(19) United States
(12) Patent Application Publication
(10) Pub. No.: US 2002/0020224 A1
(43) Pub. Date: Feb. 21, 2002

(54) Sheet-like strain sensor for confirming progress of damage of concrete structure and method for confirming progress of damage of concrete structure

(75) Inventors: Takashi Sato, Tokyo (JP); Katsumi Hino, Tokyo (JP); Kazuo Eguchi, Tokyo (JP); Tatsuro Yoshinaga, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: SHO-BOND CORPORATION, Tokyo (JP)

(21) Appl. No.: 09/843,908

(22) Filed: Apr. 30, 2001

(30) Foreign Application Priority Data
Aug. 18, 2000 (JP) 2000-248080
Dec. 12, 2000 (JP) 2000-376793

(51) Int. Cl. G01N 3/00

(52) U.S. Cl. 73/803

(57) ABSTRACT

There is a difficulty in workability of installing an optical fiber cable on a concrete structure, and when the optical fiber cable is installed on the surface of the concrete structure, the appearance of the concrete structure is spoilt by cutting the surface of the concrete structure or the like. Accordingly, there are provided a sheet-like strain sensor for confirming progress of damage of a concrete structure, in which one or a plurality of optical fiber cables are fixedly held between sheet-like bodies which are easy for the adhesive to permeate while one end/ends of the optical fiber cable/cables are pulled out; and a method for confirming progress of damage of a concrete structure by measuring strain by use of the one end of the optical fiber cable pulled out between the sheet-like bodies.

### FIELD OF THE INVENTION

The present invention relates to a sheet-like strain sensor which can easily confirm the progress of damage of a concrete structure, particularly the progress of damage of a concrete structure after reinforcement, and relates to a method for confirming the progress of the damage.

### BACKGROUND OF THE INVENTION

As a representative method of construction for reinforcing a concrete structure such as a bridge slab or the like, there is a steel plate bonding reinforcement construction method in which a steel plate is bonded integrally with the structure so as to reinforce the structure or a carbon fiber reinforced plastics (hereinafter referred to as “CFRP”) bonding construction method in which CFRP is laminated and bonded integrally with the structure.

Generally, the degree of damage of a concrete structure is inspected by observing a crack or the like in the concrete surface or estimating the concrete strength from the restitution coefficient of the concrete surface.

However, such inspection methods are not suitable for the concrete structure reinforced by the steel plate bonding construction method or the CFRP bonding construction method because the surface of the concrete structure is covered with a steel plate or CFRP.

Therefore, generally, a scaffold or the like is set up, and the concrete structure is inspected by non-destructive inspection such as infrared inspection, ultrasonic inspection, tap noise inspection, or the like. However, inspection by such methods is carried out at regular intervals, but it is short of mobility.

It is said that concrete structures have a tendency to deteriorate suddenly, once they are damaged. It is therefore necessary to find damage as early as possible and take measures earlier, from the point of view of the effect of reinforcement, the reduction of construction cost, and so on.

Taking such present circumstances into consideration, there is proposed a system in which sensors and measuring instruments are installed in a concrete structure when it is reinforced, so as to measure the behavior of the structure. In this proposal, a plurality of cables, that is, from several to hundreds of cables are laid for point measurement. Accordingly, such a system is troublesome in measurement and has a little difficulty in long-term maintenance.

Basically, the present invention solves the problems of poor mobility in the inspection methods based on non-destructive inspection as described above and troublesomeness in measurement by use of sensors and measuring instruments.

The present inventor sought a fundamental principle of means for solving the problems, in a system developed in the fields of manufacturing, laying and maintaining optical fiber cables. This system uses a manner in which Brillouin scattered light is detected from one ends of optical fiber cables so that a strain distribution given to the optical fiber cables is measured. According to this manner, the size of strain and the position of the strain can be recognized by the distances from the one ends of the optical fiber cables. Thus, if this principle is applied, linear measurement can be carried out in place of conventional point measurement.

Accordingly, first, it was considered that optical fiber cables were beforehand installed integrally with a concrete structure to measure strain and measure measurement points so that progress of damage is confirmed. However, to install the optical fiber cables directly integrally with the concrete structure, it is necessary to cut the surface of the concrete structure and bury a large number of optical fibers therein one by one. Thus, it costs much to install, or there arises a problem on the appearance of the concrete structure.

In consideration of such situation, the present inventors proposed a method in Japanese Patent No. 2981206 as follows. That is, a strain sensor in which a continuous optical fiber cable was formed into a mesh shape or a strain sensor in which a continuous optical fiber cable was folded and knit with a fixing warp thread so as to be formed into a mesh shape was laid between a concrete structure and a reinforcement material, and one end of the optical fiber cable pulled out was used to measure strain so that the progress of damage was confirmed.

This method exerted a superior effect in use in reinforcing concrete structures, but had some unsatisfactory points.

As for one of the unsatisfactory points, the work of bonding the strain sensor onto the surface of a concrete structure to thereby interpose the strain sensor between the concrete structure and the reinforcement material is not always easy because the strain sensor is a wire material.

As for another unsatisfactory point, there is a fear that the strain sensor spoils the appearance of the concrete structure because the strain sensor is installed integrally with the concrete structure in advance as described above.

### SUMMARY OF THE INVENTION

It is an object of the present invention to solve such problems.

These problems are solved at a stroke by the following means.

First, fundamentally, there is provided a sheet-like strain sensor in which one or a plurality of optical fiber cables are fixedly held between sheet-like bodies with one end/ends of the optical fiber cable/cables pulled out.

First, there is provided a sheet-like strain sensor in which an optical fiber cable formed into a mesh shape or a folded shape is fixedly held between sheet-like bodies while one end of the optical fiber cable is pulled out. Since one optical fiber cable is formed into a mesh shape or a folded shape, it is possible to lay the optical fiber cable in a wide area between the sheet-like bodies.

Secondly, there is provided a sheet-like strain sensor in which a plurality of optical fiber cables are fixedly held side by side between sheet-like bodies while one ends of the optical fiber cables are pulled out respectively. Since a plurality of optical fiber cables are arranged side by side, it is possible to lay the optical fiber cables in a wide area between the sheet-like bodies.

As a preferable example, there is provided a sheet-like strain sensor in any one of the above-mentioned configurations, in which the sheet-like bodies are made of non-woven fabric permeable to adhesive and fusible by heat treatment so that the optical fiber cable is fixed by the fusion of the non-woven fabric. According to the present invention, the method of fixing the sheet-like bodies and the optical fiber cable is not limited. However, such a fixation method results in easiness in fixing the optical fiber cable to the non-woven fabric and results in superior integration between the concrete structure and the strain sensor, as will be described later.

Further, as a preferable example, in any one of the above-mentioned configurations, there is provided a sheet-like strain sensor in which the circumference of the strain sensor is held by a removable frame which can keep the strain sensor in a plane. Although the frame may be omitted, holding the circumference of the strain sensor by the frame makes it easy to carry the strain sensor while keeping the planar condition of the sheet-like strain sensor.

Next, there is provided a method for confirming damage of a concrete structure, in which a sheet-like strain sensor according to any one of the above-mentioned configurations is bonded to the surface of a concrete structure, and one end of the optical fiber cable pulled out between the sheet-like bodies is connected to a strain meter to thereby measure strain so that the damage of the concrete structure is confirmed. If it is done by this method, the work of bonding the strain sensor onto the structure is easy because the strain sensor has a sheet-like shape. In addition, because the optical fiber cable is held between the sheet-like bodies, there is no problem on the appearance.

In the above-mentioned configuration, as an example of connection between one end of the optical fiber cable and the strain meter, there is provided connection between a connector and a strain meter. The connector is connected to one end of the optical fiber cable pulled out between the sheet-like bodies, and then connected with the strain meter. The connection method is not limited to this method.

### BRIEF DESCRIPTION OF THE DRAWINGS

FIG. 1 is an explanatory schematic view showing an example of the process for forming a sheet-like strain sensor in which an optical fiber cable is fixedly held between sheet-like bodies with one end of the optical fiber cable pulled out, (A) being a partially broken plan view, (B) being a sectional view;

FIG. 2 is an explanatory schematic view, which is a partially broken plan view following FIG. 1, showing the example of the process for forming the sheet-like strain sensor;

FIG. 3 is an explanatory schematic view showing another example of the process for forming a sheet-like strain sensor in which an optical fiber cable is fixedly held between sheet-like bodies with one end of the optical fiber cable pulled out, (A) being a partially broken plan view, (B) being a sectional view;

FIG. 4 is an explanatory schematic view showing an example of the process for forming a sheet-like strain sensor held by a frame, (A) being a partially broken plan view, (B) being a sectional view;

FIG. 5 is an explanatory schematic view showing another example of the process for forming another sheet-like strain sensor held by a frame, (A) being a partially broken plan view, (B) being an enlarged sectional view taken on line B-B of FIG. 4;

FIG. 6 is an explanatory schematic view showing an embodiment of installation of a sheet-like strain sensor in a concrete structure;

FIG. 7 is an explanatory schematic view showing an example of a sheet-like strain sensor in which a plurality of optical fiber cables are fixedly held between sheet-like bodies with one ends of the optical fiber cables pulled out, (A) being a partially broken plan view, (B) being a sectional view;

FIG. 8 is an explanatory schematic view showing an example of the process for forming a sheet-like strain sensor held by a frame, (A) being a partially broken plan view, (B) being a sectional view; and

FIG. 9 is an explanatory schematic view showing an embodiment of installation of a sheet-like strain sensor on a concrete structure.

### THE MODE FOR CARRYING OUT THE INVENTION

Next, an embodiment of the present invention will be described with reference to the drawings.

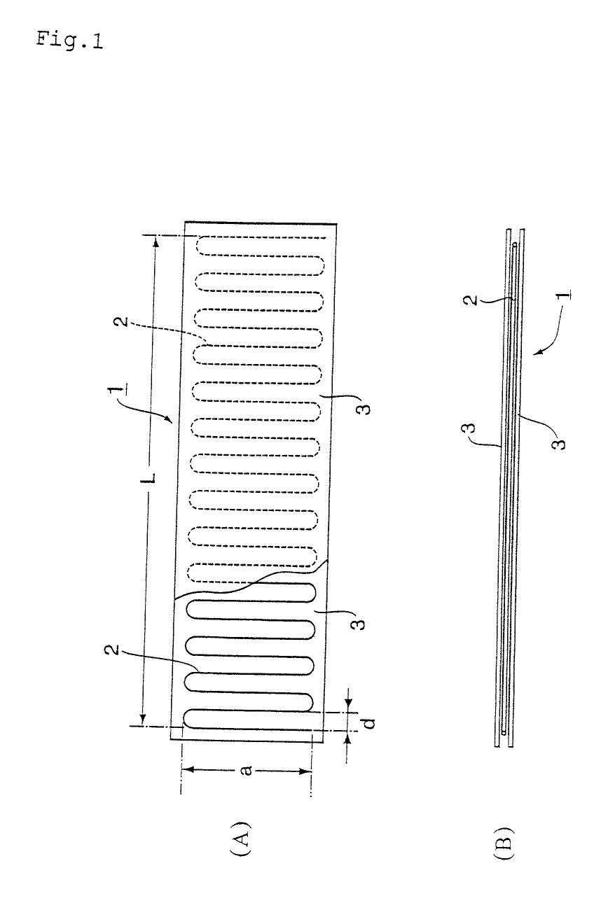

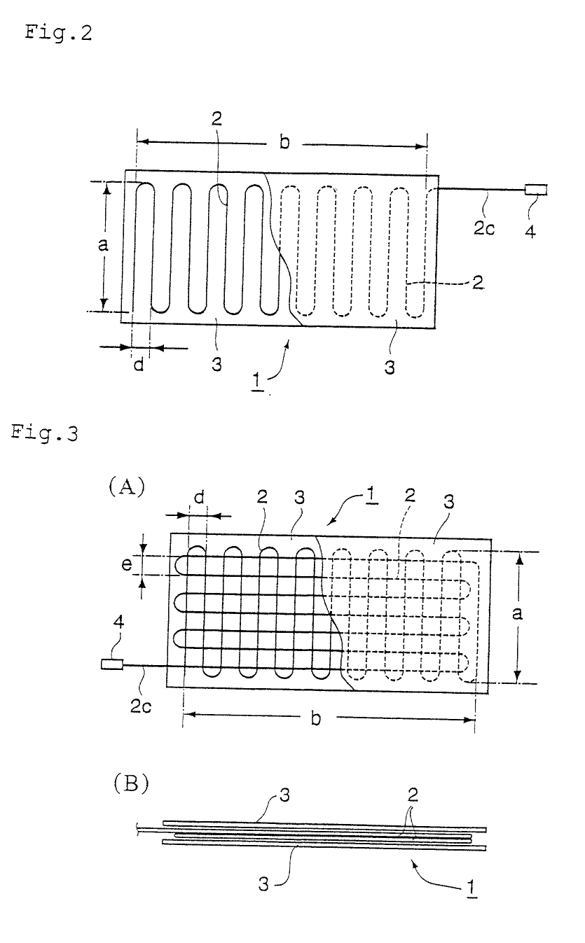

FIGS. 1 and 2 are explanatory diagrams showing an example of a sheet-like strain sensor in which an optical fiber cable is fixedly held between sheet-like bodies while one end of the optical fiber cable is pulled out.

First, as shown in FIG. 1, an optical fiber cable 2 folded in an area having a width a and a length L and at a folding interval d is fixedly held between sheet-like bodies 3 and 3.

The sheet-like bodies 3 and 3 used in this embodiment are made of non-woven fabric of polyamide resin. Non-woven fabric of polyamide resin has a property that it melts if it is heated. One of two sheets of the non-woven fabric is heated to melt so that the optical fiber cable 2 is bonded to the non-woven fabric. Thus, the optical fiber cable 2 is fixed between the sheet-like bodies 3 and 3.

The sheet-like bodies 3 and 3 and the optical fiber cable 2 may be fixed in any desired method other than the above-mentioned one. For example, if the sheet-like bodies 3 and 3 are formed of material which cannot be melted and boded, they may be bonded through adhesive.

In addition, though not limited, it is preferable that the material of the sheet-like bodies 3 and 3 is thin and easy for adhesive to permeate. Such sheet-like bodies 3 and 3 which are thin and easy for the adhesive to permeate are easily brought into close contact with the surface of a concrete structure. Thus, an error can be reduced in damage measurement.

The sheet-like strain sensor 1 formed thus is cut out, while a necessary length b as shown in FIG. 2 and a length required for making a connection to a strain meter are remained. One end 2c of the optical fiber cable 2 is pulled out, and a connector 4 for making a connection to the strain meter is attached to the end 2c.

FIG. 3 is an explanatory diagram showing another example of a sheet-like strain sensor in which an optical fiber cable is fixedly held between sheet-like bodies while one end of the optical fiber cable is pulled out.

In this sheet-like strain sensor 1 having a width a, a length b and folding intervals d and e, a mesh-like optical fiber cable2, which is, if necessary, tied at crossing portions by another fiber or the like, is held between sheet-like bodies 3 and 3 formed of non-woven fabric of polyamide resin while one end 2c of the optical fiber cable 2 is pulled out. The optical fiber cable 2 and the sheet-like bodies 3 and 3 are heated from one of the sheet-like bodies 3 and 3. Thus, the held optical fiber cable 2 is fixedly bonded to the sheet-like bodies 3 and 3 by the fusion of the heated sheet-like body 3. A connector 4 for making a connection to a strain meter is attached to the top of the pulled-out one end 2c of the optical fiber cable 2. The optical fiber cable 2 may be fixed between the sheet-like bodies 3 and 3 in any desired method. For example, if the sheet-like bodies 3 and 3 are formed of sheet-like materials which cannot be melted and boded, they may be bonded through adhesive. In addition, though not limited specifically, it is preferable to use, as the sheet-like bodies 3 and 3, bodies which are easy for adhesive to permeate, which adhere closely to the surface of a concrete structure and which is thin. Thus, an error can be reduced in damage measurement of the concrete structure.

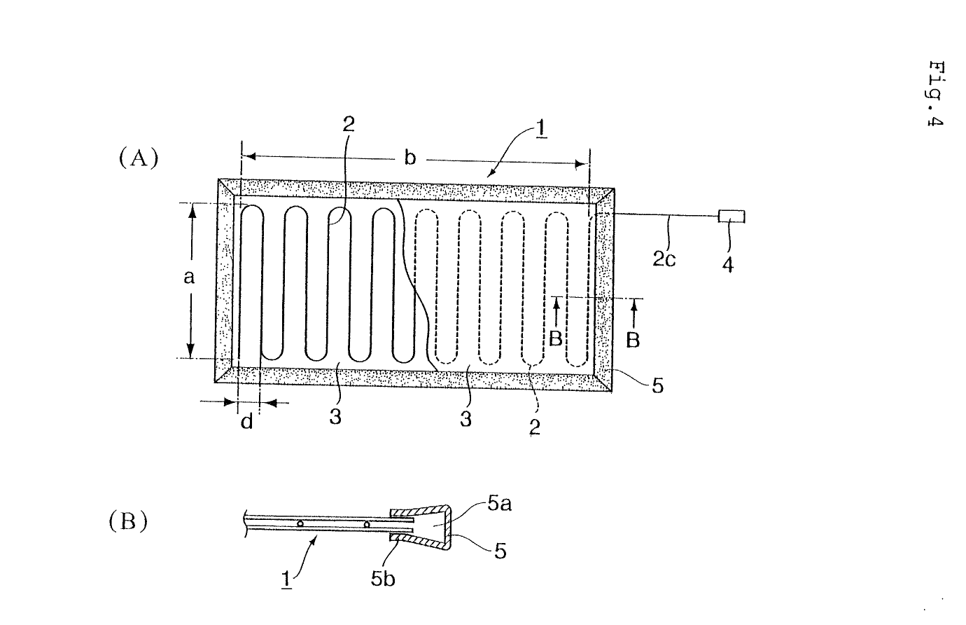

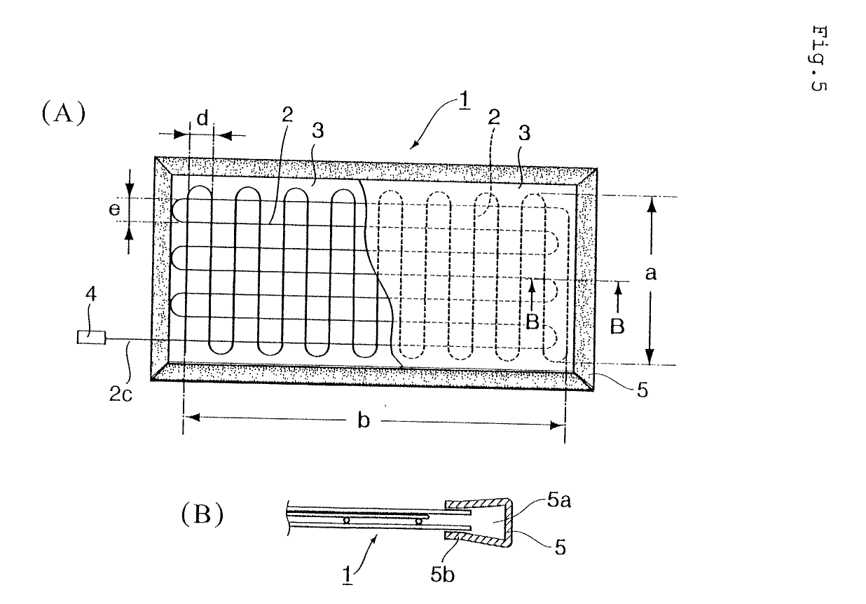

FIG. 4 shows an embodiment in which a frame is attached to the outer circumference of the sheet-like strain sensor shown in FIG. 2. FIG. 5 shows another embodiment in which a frame is attached to the outer circumference of the sheet-like strain sensor shown in FIG. 3.

A groove 5a in which the outer circumferential portion of the sheet-like strain sensor 1 can be inserted is formed in a frame 5. The outer circumferential portion of the sheet-like strain sensor 1 is inserted into this groove 5a, and the sheet-like strain sensor 1 is held by a spring structure 5b. Thus, the planar shape of the sheet-like strain sensor 1 is kept, and it is made easy to carry the sheet-like strain sensor 1 without damaging the optical fiber cable. Thus, the planar condition can be kept when the sheet-like strain sensor 1 is pasted on the surface of a concrete structure, as will be described later.

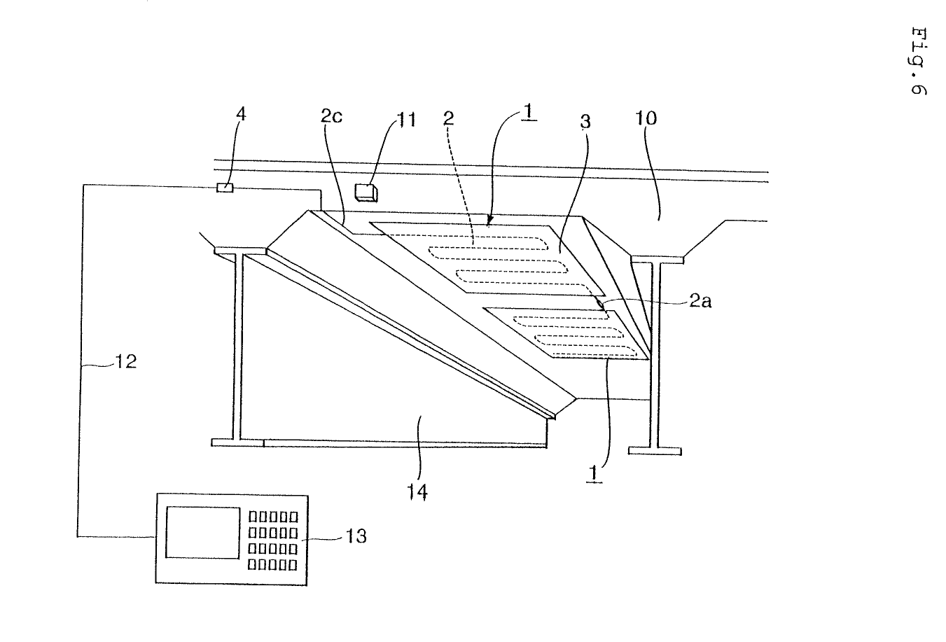

Next, the procedure for installing the above-mentioned sheet-like strain sensor and a method for measuring strain will be described with reference to FIG. 6. The sheet-like strain sensor 1 may be installed on the surface of a concrete structure in advance or at the time of reinforcement. Incidentally, in this embodiment, the sheet-like strain sensor 1 is installed on a concrete slab at the time of reinforcement by way of example. Not to say, however, applications of the present invention are not limited to this embodiment.

The sheet-like strain sensor 1 is bonded to the lower surface of a concrete slab 10 through adhesive. In the case of the sheet-like strain sensor 1 shown in FIGS. 4 and 5, a frame 5 is removed after the sheet-like strain sensor 1 has been pasted. A connector 4 is attached to one end of an optical fiber cable 2 which is pulled out. The connector 4 is usually received in a connector storage box 11. To measure the progress of damage of the slab 10, a strain meter 13 is connected to the connector 4 through a lead wire 12. Thus, a circuit is formed by the sheet-like strain sensor 1 and the strain meter 13 so as to measure the distribution of strain. The slab 10 is mounted on a main girder 14.

Incidentally, at least one sheet-like strain sensor 1 is installed in accordance with the area of the place which is required to be monitored. In this embodiment, two sheet-like strain sensors 1 are attached to the lower surface of the concrete slab 10. A top end of an optical fiber cable 2a pulled out from one of the sheet-like strain sensors 1 is connected to an optical fiber cable 2 of the other sheet-like strain sensor 1.

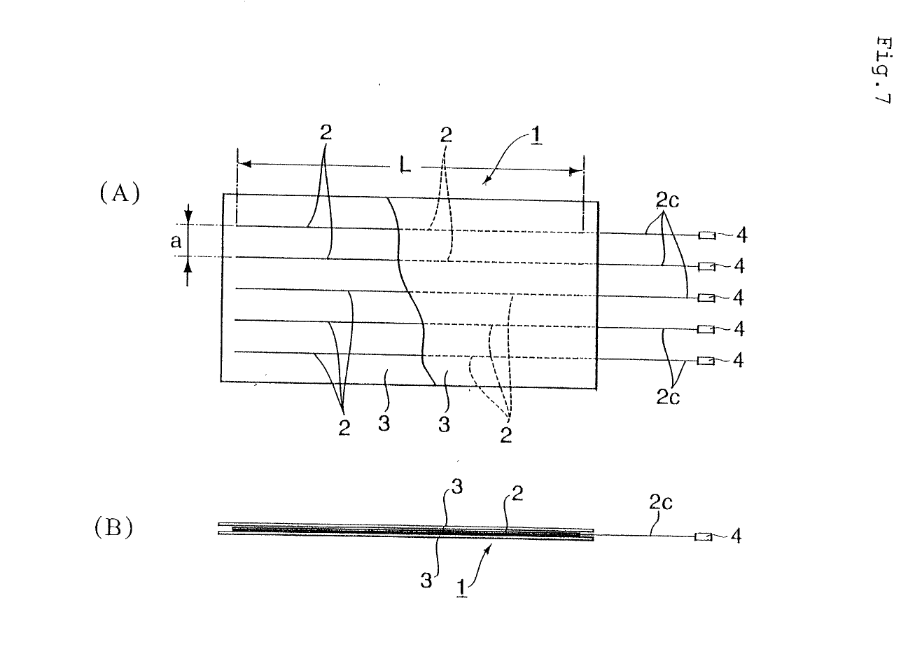

FIG. 7 is an explanatory diagram showing an example of a sheet-like strain sensor in which a plurality of optical fiber cables are fixedly held between sheet-like bodies while one ends of the optical fiber cables are pulled out.

In this sheet-like strain sensor 1, a plurality of optical fiber cables 2 are fixedly held in parallel at an interval e between sheet-like bodies 3 and 3 made of non-woven fabric. One ends 2c of the optical fiber cables are pulled out between the sheet-like bodies 3 and 3.

The sheet-like bodies 3 and 3 used in this embodiment are made of non-woven fabric of polyamide resin. Non-woven fabric of polyamide resin has a property that it melts if it is heated. One of two sheet-like non-woven fabric is heated to melt so that the optical fiber cables 2 are bonded to the non-woven fabric. Thus, the optical fiber cables 2 are fixed between the sheet-like bodies 3 and 3.

The sheet-like bodies 3 and 3 and the optical fiber cables 2 may be fixed in any desired method other than the above-mentioned one. For example, if the sheet-like bodies 3 and 3 are formed of materials which cannot be melted and boded, they may be bonded through adhesive.

In addition, though the material of the sheet-like bodies 3 and 3 is not limited, it is preferable that they are thin and easy for the adhesive to permeate. Such sheet-like bodies which is thin and easy for the adhesive to permeate are brought into close contact with a surface of a concrete structure easily. Thus, an error can be reduced in damage measurement.

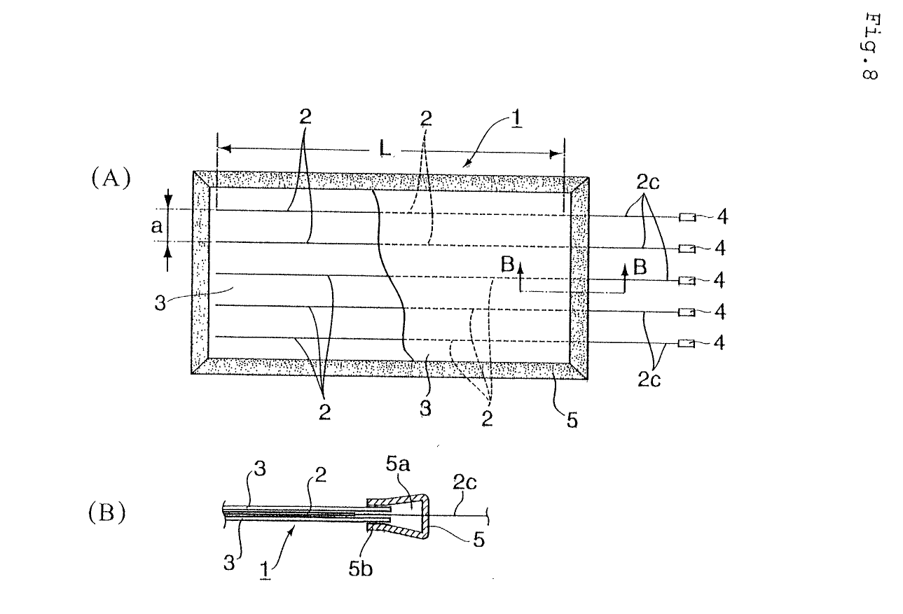

FIG. 8 shows an embodiment in which a frame is attached to the outer circumference of the sheet-like strain sensor shown in FIG. 7.

A groove 5a in which the outer circumferential portion of the sheet-like strain sensor 1 can be inserted is formed in a frame 5. The outer circumferential portion of the sheet-like strain sensor 1 is inserted into this groove 5a, and the sheet-like strain sensor 1 is held by a spring structure 5b. Thus, the planar shape of the sheet-like strain sensor 1 is kept, and it is made easy to carry the sheet-like strain sensor 1 without damaging the optical fiber cables. Thus, the planar condition can be kept when the sheet-like strain sensor 1 is pasted on the surface of a concrete structure, as will be described later.

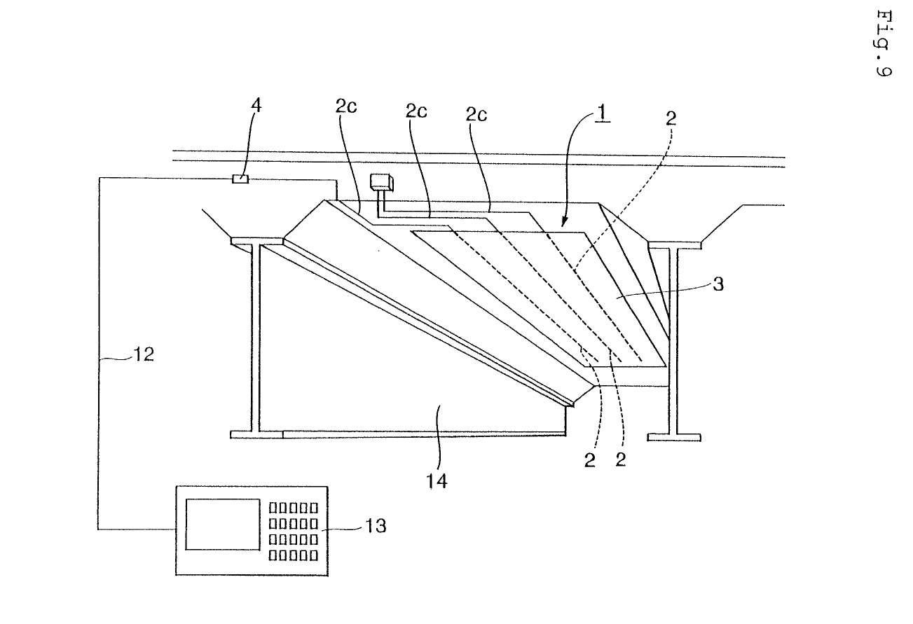

Next, the procedure for installing the above-mentioned sheet-like strain sensor and a method for measuring strain will be described with reference to FIG. 9. The sheet-like strain sensor 1 may be installed on the surface of a concrete structure in advance or at the time of reinforcement. Incidentally, in this embodiment, the sheet-like strain sensor 1 is installed on a concrete slab before reinforcement, by way of example. Not to say, however, applications of the present invention are not limited to this embodiment.

The sheet-like strain sensor 1 is bonded to the lower surface of a concrete slab 10 through adhesive. In the case of the sheet-like strain sensor 1 shown in FIG. 8, the frame 5 is removed after the sheet-like strain sensor 1 has been pasted. Connectors 4 are attached to one ends 2c of optical fiber cables 2 which are pulled out. The connectors 4 are usually received in a connector storage box 11. The slab 10 is mounted on a main girder 14.

When the progress of damage of the slab 10 is to be measured, connectors 4 for optical fiber cables 2 at places to be measured are taken out from the connector storage box 11, and connected to a strain meter 13 through a lead wire 12. Thus, a circuit is formed by the sheet-like strain sensor 1 and the strain meter 13. Thus, the progress of damage of the concrete structure is known by measuring the distribution of strain.

Incidentally, at least one sheet-like strain sensor 1 is installed in accordance with the area of the place which is required to be monitored.

Since the present invention is configured thus, it has the following effects.

According to claims 1 to 7, the sheet-like strain sensor in which an optical fiber cable/cables are formed fixedly between sheet-like bodies has a planar shape. Thus, the sheet-like strain sensor is attached to a structure easily.

According to claims 1 to 7, the sheet-like strain sensor in which an optical fiber cable/cables are formed fixedly between sheet-like bodies has a planar shape. Thus, the sheet-like strain sensor can be pasted directly on a surface of a concrete structure without cutting the surface of the concrete structure and burying the strain sensor therein. Accordingly, the appearance of the concrete structure is rarely spoilt.

According to claim 2, the sheet-like strain sensor in which one optical fiber cable formed into a mesh shape or a folded shape is held between sheet-like bodies can measure strain in a wide area of a concrete structure. Accordingly, the sheet-like strain sensor can confirm damage over the wide area of the concrete structure extremely effectively in confirming the damage of the concrete structure.

According to claim 4, the sheet-like strain sensor in which a plurality of optical fiber cables are held between sheet-like bodies does not have to be buried in the surface of a concrete structure as described in the conventional case. Accordingly, the work can be done efficiently.

According to claim 4, fusible non-woven fabric is used as the sheet-like bodies for holding the sheet-like strain sensor. Accordingly, the optical fiber cable/cables held between the sheet-like bodies can be easily fixed to the sheet-like bodies by heating one of the sheet-like bodies.

According to claim 5, the circumference of the sheet-like strain sensor is held by a removable frame which can keep the planar shape of the sheet-like strain sensor. Accordingly, the sheet-like strain sensor can be carried easily, and the optical fiber cable/cables can be prevented from being damaged. In addition, the planar condition of the sheet-like strain sensor can be kept when the sheet-like strain sensor is pasted on a concrete structure.

According to claims 6 and 7, the sheet-like strain sensor stated in any one of claims 1 to 5 is bonded to the surface of a concrete structure, and a circuit is formed between this sheet-like strain sensor and a strain meter so as to measure strain of the concrete structure. Accordingly, the progress of damage of the concrete structure can be recognized easily.

What is claimed is:

1. A sheet-like strain sensor for confirming progress of damage of a concrete structure, wherein one or a plurality of optical fiber cables are fixedly held between sheet-like bodies while one end/ends of said optical fiber cable/cables are pulled out.

2. A sheet-like strain sensor for confirming progress of damage of a concrete structure, wherein an optical fiber cable formed into a mesh shape or a folded shape is fixedly held between sheet-like bodies while one end of said optical fiber cable is pulled out.

3. A sheet-like strain sensor for confirming progress of damage of a concrete structure, wherein a plurality of optical fiber cables are fixedly held side by side between sheet-like bodies while one ends of said optical fiber cables are pulled out respectively.

4. A sheet-like strain sensor for confirming progress of damage of a concrete structure according to any one of claims 1 through 3, wherein said sheet-like bodies are made of non woven fabric permeable to adhesive and fusible by heat treatment so that said optical fiber cable/cables are fixed by fusion of said non-woven fabric.

5. A sheet-like strain sensor for confirming progress of damage of a concrete structure according to any one of claims 1 through 4, wherein a circumference of said sheet-like strain sensor is held by a removable frame which can keep said sheet-like strain sensor in a plane.

6. A method for confirming progress of damage of a concrete structure, wherein a sheet-like strain sensor for confirming progress of damage of a concrete structure according to any one of claims 1 through 5 is bonded to a surface of said concrete structure, and one end/ends of an optical fiber cable/cables pulled out between sheet-like bodies are connected to a strain meter to thereby measure strain so that said progress of damage of said concrete structure is confirmed.

7. A method for confirming progress of damage of a concrete structure according to claim 6, wherein said optical fiber cable/cables are connected with said strain meter by attaching a connector/connectors to said one end/ends of said optical fiber cable pulled out between said sheet-like bodies, and connecting said connector/connectors and said strain meter through a lead wire.
